(19) United States
(12) Patent Application Publication
(10) Pub. No.: US 2018/0276761 A1
(43) Pub. Date: Sep. 27, 2018

(54) Object Oriented Framework for Modelling Financial Transactions via a Communication Medium

(71) Applicant: Robert Benjamin Ulph, London (GB)

(72) Inventor: Robert Benjamin Ulph, London (GB)

(21) Appl. No.: 15/469,261

(22) Filed: Mar. 24, 2017

(51) Int. Cl. G06Q 40/00; G06Q 50/18; G06Q 40/04; G06F 3/0482; G06F 3/0486

(52) U.S. Cl. CPC G06Q 40/12; G06Q 50/18; G06F 3/0486; G06Q 40/04; G06F 3/0482; G06Q 40/10

(57) ABSTRACT

A method and system that enables the representation of financial transactions via the Internet or a downloadable computer program is described. Users of the system draw up a transaction diagram consisting of boxes and arrows representing parties to the transaction and existing and proposed financial relationships between them. By means of contextual menus users can select from a range of related financial instruments which the arrows represent. The user is able to enter terms of the financial instruments through a grid and obtain (i) links to relevant legal topics available through an independent subscription service and (ii) standard documentation based on the details he has entered. The transaction diagram can be saved as a file for later access. Users include investors, arrangers and borrowers in the financial markets as well as advisors such as lawyers and accountants.

### CROSS-REFERENCES TO RELATED APPLICATIONS

This application claims the benefit of the Applicant's prior provisional application No. 62/312,693 filed on 24 Mar. 2016.

### SPECIFICATION

### Background of the Invention

The present invention is in the technical field of computer modelling. It provides for a system of display of financial transactions on a computer screen through a system of boxes and arrows.

In finance, market participants will frequently draw up transaction diagrams to represent and communicate existing and proposed financial relationships between legal entities. These will be done on paper or by making use of an all-purpose diagram production software tool such as Microsoft Visio. No dedicated service exists for the production of such diagrams. The present invention is a means to provide such a service. It could be delivered as a downloadable application or through the Internet.

### Prior Art

The only relevant prior art of which I am aware is US20050187866A1 a “Method and system for executing financial transactions via a communication medium” where the inventor claims (inter alia) for a “method for designing a structure for a transaction diagrammatically and assigning corresponding attributes to the structure design”. However the patent (at [0051]) simply describes the (obvious) concept of having a canvas on which boxes and arrows could be added. It does not describe how this would be achieved in anything like sufficient detail for a computer programmer of ordinary skill to be able to produce the service. There seems to be no inventive step.

### SUMMARY OF THE INVENTION

The present invention is a means to enable participants in the financial markets to draw up financial transaction diagrams using a dedicated computing service. The utility of such a service is (a) in the visualisation it provides, (b) in the potential for it to produce basic template documentation and (c) in the potential for it to provide links to relevant legal and taxation topics through a subscription service.

As mentioned earlier, the present invention provides for the preparation of financial transactions with a system of boxes and arrows. The user can add boxes to a canvas to represent legal entities. Within those boxes the name of the entity and its jurisdiction of incorporation can be entered. For the arrows there is an object model of various types of arrows which can be drawn between the boxes. These arrows represent different types of fundamental financial objectives. They are also differentiated on the basis of whether they already existing or are arrangements planned for the future.

A further object model contains a categorization of different types of financial instrument. This follows the fundamental financing objectives referred to in 0005 above, but is broken down further to reflect the fact that different types of instrument can be used to achieve any of the fundamental objectives. Each arrow is considered to have one such instrument which it represents. By moving the cursor over an arrow and right-clicking the user is presented with a menu of the available types of instrument from which he can choose.

A third object model contains a set of interfaces identifying topics of legal relevance, there being one such interface for each of the fundamental financing objectives described in 0005 above. These interfaces can consult a dynamic linked library for the relevant jurisdiction to identify legal topics which should be considered in relation to the transaction in that relevant jurisdiction.

The design for providing the service would consist of (i) a toolbox for selection of the box or arrows to be added, (ii) a canvas on which the user would place the boxes and arrows, (iii) a grid for entering and storing the terms of a selected instrument and (iv) a panel for listing legal topics relevant to a selected instrument.

### BRIEF DESCRIPTION OF THE DRAWINGS

FIG. 1 is a class diagram of the object model for the arrows;

FIG. 2 is a class diagram of the object model for instruments for security, credit support and passing through cash flows and assets;

FIG. 3 is a class diagram of the object model for instruments for funding and swaps;

FIG. 4 is a class diagram of the object model for the legal interfaces.

[Left blank to preserve numbering]

### DETAILED DESCRIPTION OF THE INVENTION

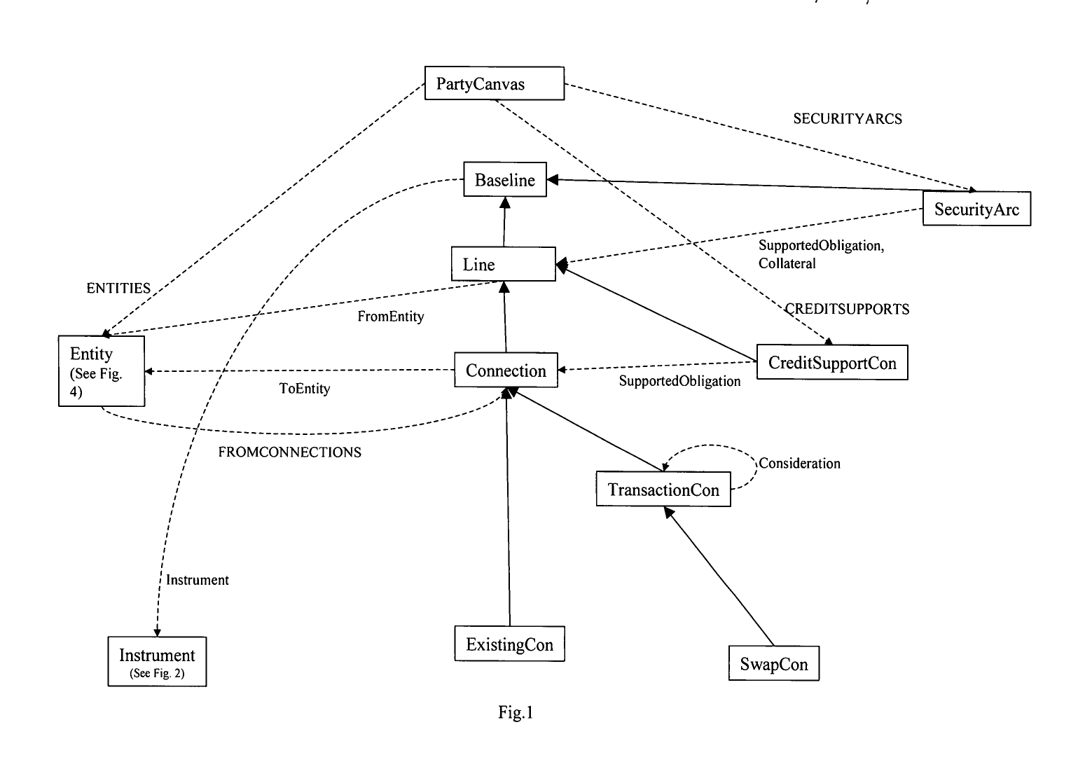

Referring now to the object model for the arrows in more detail, shown in FIG. 1 the classes and their related Instrument types are as follows:

| | | | Related |
|---|---|---|---|
| | | | Instrument |
| | | | Type (see 0017 |
| Class | Description | Inherits From | below) |
| BaseLine | Most basic | Object | Instrument |
| | class. | | |
| Line | Straight arrow | BaseLine | FromEInstrument |
| | from an Entity | | |
| Connection | Arrow from | Line | EtoEInstrument |
| | one Entity to | | |
| | another | | |
| ExistingCon | Single arrow | Connection | PassThroughBase |
| | from one Entity | | or Funding Base |
| | to another | | |
| | representing an | | |
| | existing | | |
| | obligation | | |
| TransactionCon | Single arrow | Connection | PassThroughBase |
| | from one Entity | | or FundingBase |
| | to another | | |
| | relating to a | | |
| | proposed | | |
| | obligation. It | | |
| | relates to | | |
| | another | | |
| | TransactionCon | | |
| | which is the | | |
| | consideration | | |
| | for the first. | | |
| SwapCon | One leg of a | TransactionCon | SwapLeg |
| | swap. | | |
| CredSupCon | Single arrow | Line | CredSup |
| | from an Entity | | |
| | to a Connection | | |
| | showing credit | | |
| | support. | | |
| SecurityArc | Curved arrow | BaseLine | SecurityBase |
| | to a Connection | | |
| | showing a | | |
| | grant of | | |
| | security in | | |
| | support of that | | |
| | Connection. | | |
| LineArc | SecurityArc | SecurityArc | SecurityBase |
| | from a | | |
| | Connection to | | |
| | represent that | | |
| | Connection is | | |
| | the collateral. | | |
| EntityArc | SecurityArc | SecurityArc | SecurityBase |
| | from an Entity | | |
| | where the | | |
| | collateral | | |
| | cannot be | | |
| | represented. | | |

The user should be able to select any of the above, with the exception of BaseLine, Line and SecurityArc and add them to the diagram. This can be done with a toolbar and mouse events to enable them to be drawn between Entities or Connections as appropriate.

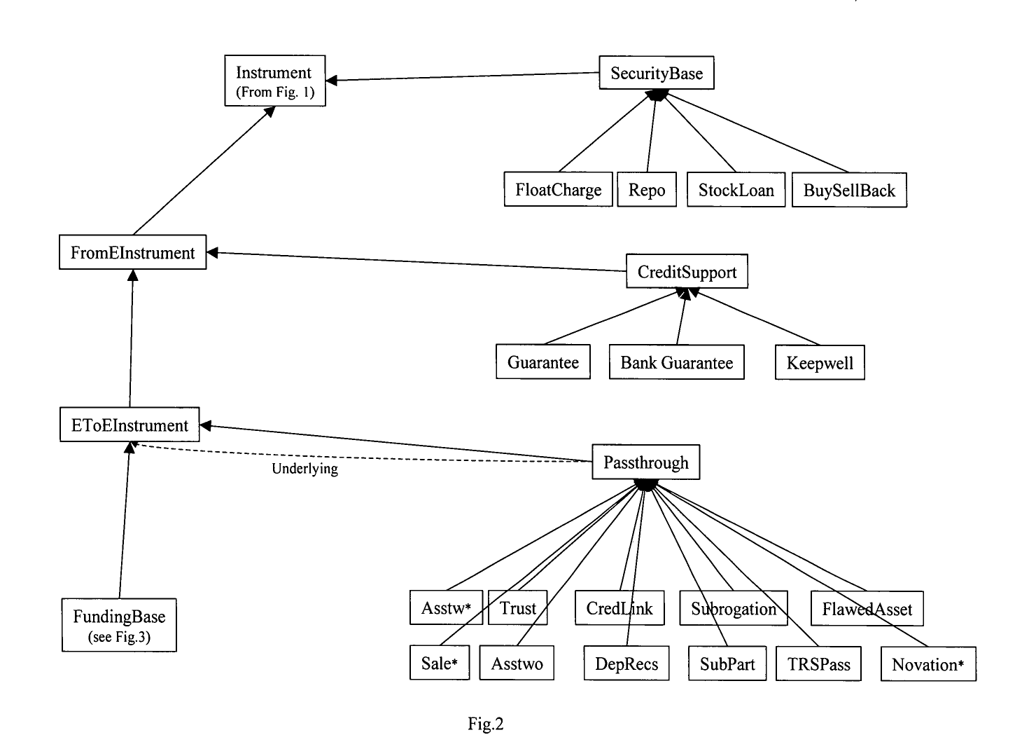

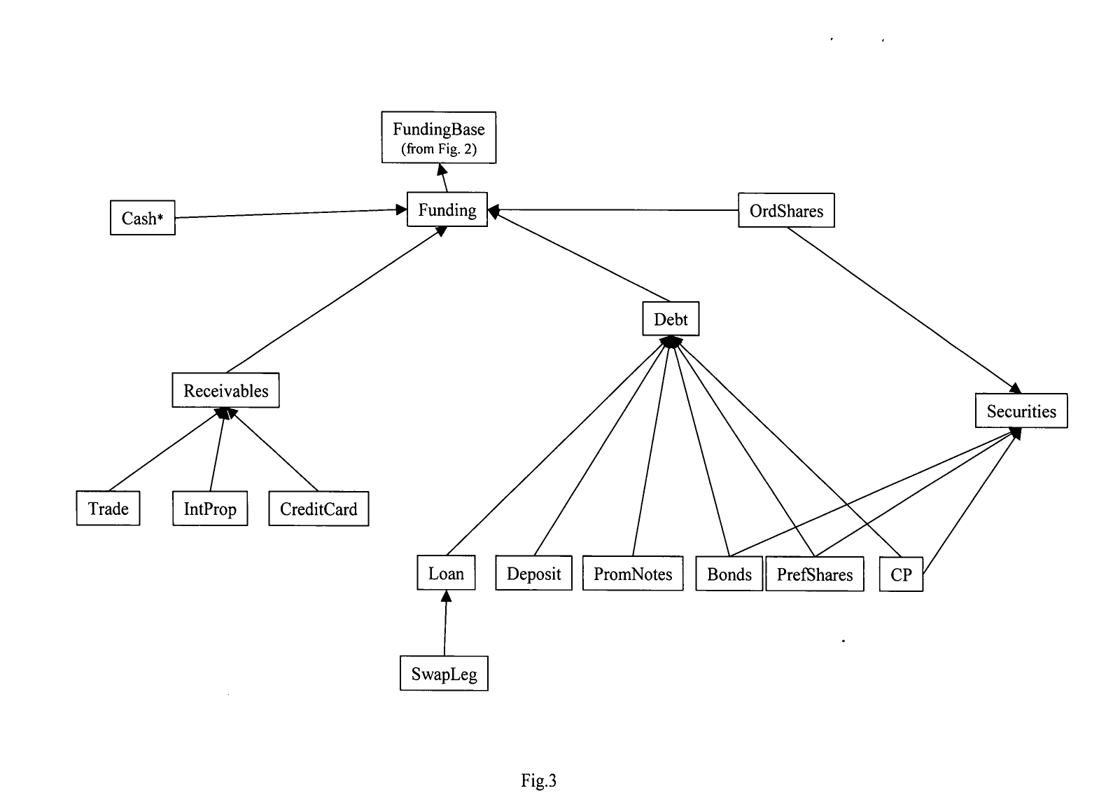

Referring now to the object model for the Instruments in more detail, shown in FIGS. 2 and 3 these are:

| Class | Description | Inherits From |
|---|---|---|
| Instrument | Base Class | Object |
| FromEInstrument | Holds a | Instrument |
| | reference to the | |
| | Entity that the | |
| | related arrow is | |
| | drawn from | |
| CreditSupport* | Support by one | FromEInstrument |
| | Entity for | |
| | another Entity's | |
| | obligations in | |
| | the form of a | |
| | guarantee etc. | |
| Guarantee | Undertaking to | CreditSupport |
| | pay the debts of | |
| | another party if | |
| | that party | |
| | defaults. | |
| BankGuarantee | Guarantee | CreditSupport |
| | made by a | |
| | bank. | |
| KeepWellAgreement | Agreement to | CreditSupport |
| | keep a | |
| | (subsidiary) in | |
| | sufficient funds | |
| | to meet its | |
| | obligations. | |
| EtoEInstrument | Holds a | Instrument |
| | reference to the | |
| | Entity that the | |
| | related arrow is | |
| | drawn to | |
| FundingBase | | EtoEInstrument |
| Funding* | | FundingBase |
| Cash* | A payment of | Funding |
| | cash | |
| Debt | Any sort of | Funding |
| | debt obligation, | |
| | where interest | |
| | is payable. So | |
| | including most | |
| | sorts of funding | |
| | arrangement, | |
| | but not ordinary | |
| | shares. | |
| Loan | | Debt |
| SwapLeg | One leg of a | Loan |
| | swap | |
| | agreement, | |
| | essentially | |
| | having payment | |
| | amounts like a | |
| | Loan | |
| CP | Commercial | Debt |
| | Paper | |
| PromNotes | Promissory | Debt |
| | Notes. Like a | |
| | loan but a | |
| | simple promise | |
| | to pay with | |
| | almost no other | |
| | terms. | |
| PrefShares | Preference | Debt |
| | Shares. Hybrid | |
| | between debt | |
| | and equity. | |
| Bonds | Bonds, like an | Debt |
| | IOU. | |
| Deposit | A bank deposit. | Debt |
| | This is | |
| | effectively a | |
| | form of funding | |
| | for a bank. | |
| OrdShares | Ordinary | Funding |
| | Shares | |
| Receivables | Diverse | Funding |
| | payment | |
| | obligations | |
| Trade | General | Receivables |
| | business | |
| | receivables | |
| IntProp | Royalties | Receivables |
| CredCard | Debts owing | Receivables |
| | under credit | |
| | card | |
| | agreements | |
| PassThrough* | Instrument | EToEInstrument |
| | whereby the | |
| | benefits of a | |
| | cash-generating | |
| | asset may be | |
| | transferred | |
| | from one Entity | |
| | to another | |
| Sale | | PassThrough |
| Assignment with | A transfer of | PassThrough |
| Notice | contractual | |
| | rights where the | |
| | debtor is given | |
| | notice of the | |
| | assignment. | |
| Assignment without | Where the | PassThrough |
| Notice | debtor is not | |
| | given notice of | |
| | the assignment. | |
| Trust | Retention by | PassThrough |
| | one party of the | |
| | legal title to an | |
| | asset while | |
| | transferring the | |
| | beneficial | |
| | ownership to | |
| | another party. | |
| Novation | Substitution of | PassThrough |
| | one party to a | |
| | contract for | |
| | another. | |
| Subparticipation | Simple | PassThrough |
| | agreement to | |
| | pay on all | |
| | amounts | |
| | received in | |
| | respect of a | |
| | debt. | |
| FlawedAsset | Where a | PassThrough |
| | customer | |
| | deposits money | |
| | with a bank on | |
| | the agreement | |
| | that the deposit | |
| | will be flawed | |
| | except to the | |
| | extent that | |
| | another party | |
| | meets certain | |
| | payment | |
| | obligations it | |
| | has to the | |
| | bank.Esoteric. | |
| DepRecs | Depositary | PassThrough |
| | Receipts. An | |
| | asset is | |
| | transferred to a | |
| | depositary who | |
| | issues receipts | |
| | to evidence | |
| | rights in that | |
| | asset. | |
| Subrogation | Arrangement | PassThrough |
| | where the | |
| | purchaser of the | |
| | cashflow | |
| | guarantees | |
| | payments by | |
| | the debtor such | |
| | that the | |
| | recipient of the | |
| | cashflow is | |
| | obliged to pass | |
| | payments on | |
| | the purchaser. | |
| | Esoteric. | |
| Credit-linked Notes | Essentially a | PassThrough |
| | subparticipation | |
| | where | |
| | payments are | |
| | made through | |
| | Bonds | |
| Total Return Swap | Like a | PassThrough |
| | subparticipation | |
| | made through a | |
| | Swap | |
| Cancellation | Cancellation of | PassThrough |
| | debt has much | |
| | the same effect | |
| | as selling it | |
| | back to the | |
| | lender. It is | |
| | something that | |
| | is done in | |
| | unwinding | |
| | transactions so | |
| | logically | |
| | belongs here. | |
| SecurityBase* | For security, to | Instrument |
| | hold details of | |
| | the collateral | |
| | and the | |
| | obligation | |
| | which it is | |
| | granted as | |
| | security for. | |
| FixedCharge | Security, like a | SecurityBase |
| | mortgage, but, | |
| | for the purposes | |
| | here, where the | |
| | collateral is in | |
| | the form of a | |
| | debt obligation. | |
| Repo | Repo | SecurityBase |
| | transaction | |
| StockLoan | Stock Loan | SecurityBase |
| BuySellBack | Agreement to | SecurityBase |
| | Buy and Sell | |
| | Back an asset | |

*These Instruments are considered to be the fundamental financial objectives referred to in 0005 above.

The arrows should be drawn differently to reflect what they represent. It is proposed that an arrow that represents an existing arrangement be represented by means of a dotted line and those that represent planned arrangements be represented by means of a solid line. An arrow which represents a PassThrough should be represented by means of double lines. An arrow which represents a swap should have open arrowheads whereas other arrows should have solid arrowheads. An arrow which represents Cash should have a small arrowhead.

The user selects an Instrument which is to relate to a given arrow by moving the cursor over that arrow and right-clicking to access a context menu. The context menu lists those Instruments which inherit from the fundamental financial objective to which the arrow relates.

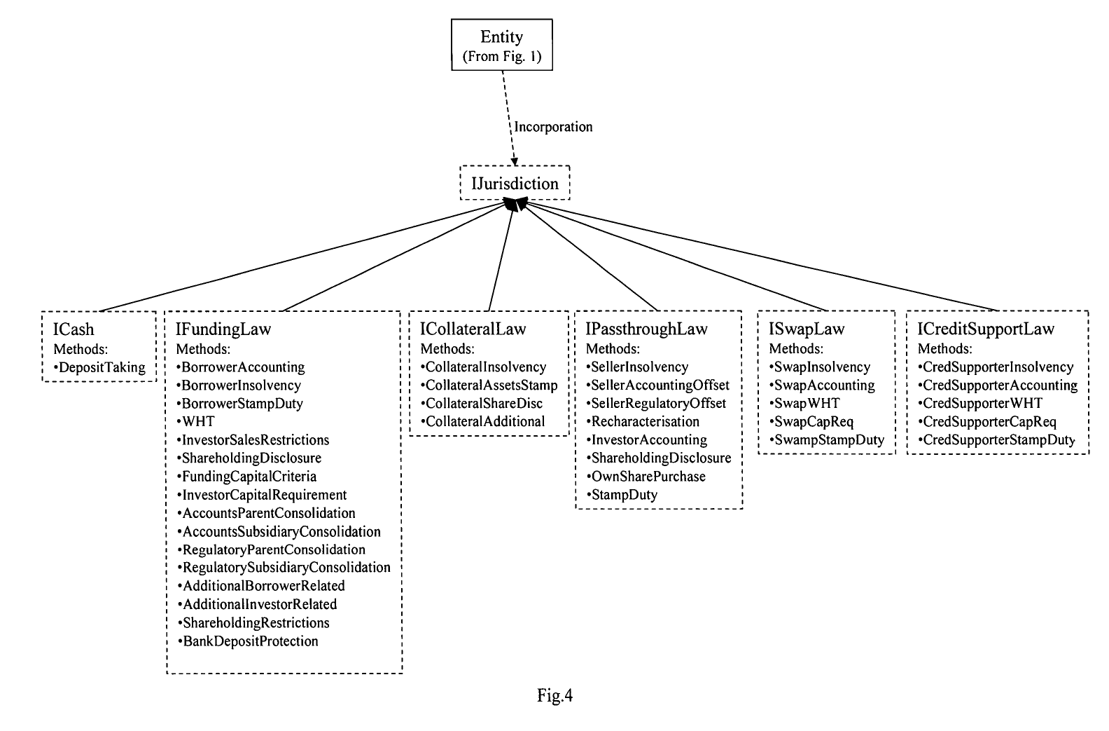

Referring now to the object model for the Interfaces in more detail, shown in FIG. 4, it will be noted that there is one of these for each type of fundamental financial objective. If the user selects an Instrument then each method of the interface object for the fundamental financial objective from which that Instrument inherits will be called. The service must select the jurisdiction for which the law is relevant for that method and call that method in the dynamic linked library which implements the interface for the relevant jurisdiction. So for instance in the case of a Bond issue by an Entity incorporated in Japan, the service must call the WHT method for the Japanese implementation of IfundingLaw which method must return links to topics on withholding taxes on bonds issued in Japan. These links must then be displayed in the service.

An additional feature of the service should be the conversion of diagrams into a “post-completion” version. In such a version all Cash and Sale Instruments would cease to be represented and all planned arrangements would be converted to appear as existing arrangements.

The service should also allow users to save and restore transaction diagrams, and print them as images.

The service described could be produced by computer programmers of ordinary skill using any distributed computer programming language or, in the case of an Internet service, using a combination of hyper text markup language (html), javascript and the html canvas element.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A method for designing financial structure diagrams with boxes and arrows as a computerised service comprising:
(a) the object model described in 0015 above;
(b) the object model described in 0017 above; and
(c) the use of contextual menus to select instruments relating to the arrows.

2. A method for identifying and displaying legal, tax and regulatory topics relevant to the object model described in 0017 above using the object model described in 0019 above.

3. The method for conversion of transaction diagrams into “post-completion” versions.
